(19) United States
(12) Patent Application Publication
(10) Pub. No.: US 2010/0302578 A1
(43) Pub. Date: Dec. 2, 2010

(54) SYSTEM AND METHOD OF REMOTE MACHINE SERVICING

(75) Inventor: James Michael Rego, Webster, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/473,995

(22) Filed: May 28, 2009

(51) Int. Cl. G06F 15/00

(52) U.S. Cl. 358/1.15

(57) ABSTRACT

A service system for servicing a printing system includes a processor, a printing device, and a computer-readable storage medium in communication with the processor. The computer-readable storage medium may include one or more programming instructions for receiving a request to service the printing device, determining a number of carbon credits associated with driving a vehicle from a service center to a location of the printing device, offering a selected number of carbon credits to a customer to incent acceptance of remote repair of the printing device based at least in part on the determining, and causing remote service to be performed relative to the printing device responsive to receiving an acceptance of the offer of the selected number of carbon credits so that the vehicle need not be driven from the service center to the location of the printing device.

### BACKGROUND

1. Technical Field

This application relates to servicing and repairing machines, such as printers and more particularly to a method in which a customer is provided incentive for servicing machines remotely.

2. Description of Related Prior Art

Diagnosis and repair of complex electromechanical devices requires sophisticated techniques and highly trained service engineers. Conventionally, service engineers travel to a customer site in order to perform repairs as a result of a customer call. Current on-site service processes for diagnosis and repair of electromechanical devices can include significant device downtime, which results in reduced productivity. After requesting an engineer, the customer waits for the engineer's arrival which increases downtime of the device and interrupts the associated workflow. Once on site, the engineer uses a repair analysis procedure that is typically a set of computationally coded steps that the service engineer executes. A step or test could include, for example, a request for information, a diagnostic routine or an electrical or visual check on the device. The service engineer is directed to one of a plurality of steps in the repair analysis procedure depending on the outcome of each test. The process is repeated after the next step until a conclusion is reached.

Alternatively, remote servicing can be performed. Methods of remote repair for printing systems have been known in the art. For example, U.S. Pat. No. 5,615,015 to Krist et al. is incorporated by reference herein in its entirety to further describe an example of an exemplary printing system. A remote repair operation enables an immediate response to a customer call. A service center receives a request for the repair of an electromechanical device. The request identifies the malfunctioning device and a fault code identifying a specific malfunction. A repair analysis procedure is automatically deployed and performed from the service center by a service engineer and/or an automated repair program. The repair analysis procedure directs execution of a computationally coded sequence of steps. The repair analysis procedure might direct the engineer or repair program to request additional information, follow a diagnostic routine from the service center, and/or conduct an electrical check on the device. A subsequent step is then initiated based on the received response. The process is repeated until a conclusion is reached. Such remote repair can save time and environmental resources, especially within a carbon credit market.

Global awareness has led to the creation of carbon credit markets along with international discussion of such markets. A carbon credit market is a market which attempts to offset carbon and equivalent emissions sent into the atmosphere through investment opportunities. Entities are offered the chance to invest in projects that will reduce such emissions. In return, these entities can receive carbon credits issued by the project leaders or another appointed organization. These carbon credits are typically independently verified by a designated third party. The designated third party also monitors the difference between baseline and actual emissions to ensure appropriate amounts of carbon credits are issued.

In some cases, an entity could be required to acquire a specified number of carbon credits. This requirement could result from either voluntary or regulatory carbon credit market systems. Entities, such as large corporations, are interested in new ways to amass carbon credits and participate in a global commitment to reduce carbon and equivalent emissions.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “machine” is a reference to one or more machines and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a service system for servicing a printing system may include a processor, a printing device, and a computer-readable storage medium in communication with the processor. The computer-readable storage medium may include one or more programming instructions for receiving a request to service the printing device, determining a number of carbon credits associated with driving a vehicle from a service center to a location of the printing device, offering a selected number of carbon credits to a customer to incent acceptance of remote repair of the printing device based at least in part on the determining, and causing remote service to be performed relative to the printing device responsive to receiving an acceptance of the offer of the selected number of carbon credits so that the vehicle need not be driven from the service center to the location of the printing device.

In an embodiment, a system for providing an incentive to remotely service a machine may include a processor, an output device in communication with the processor, and a computer-readable storage medium in communication with the processor. The computer-readable storage medium may include one or more programming instructions for receiving a request to service the machine, determining a number of carbon credits associated with driving a vehicle from a service center to a location of the machine, determining a number of offered carbon credits, offering the number of offered carbon credits to a customer to incent acceptance of remote repair of the machine, receiving an acceptance of the number of offered carbon credits, providing the number of offered carbon credits to the customer, and issuing a command to remotely service the machine.

In an embodiment, a method of servicing a machine may include receiving a request to service the machine, automatically determining through a processor a number of carbon credits associated with driving a vehicle from a service center to a location of the machine, offering a number of offered carbon credits to a customer to incent acceptance of remote repair of the machine, receiving an acceptance of the number of offered carbon credits, providing the number of offered carbon credits to the customer, and remotely servicing the machine.

### BRIEF DESCRIPTION OF THE DRAWINGS

Aspects, features, benefits and advantages of the present application will be apparent with regard to the following description and accompanying drawings, of which:

FIG. 1 depicts a flow diagram of an exemplary method of incentivizing remote servicing of a machine according to an embodiment.

FIG. 2 is a block diagram of exemplary internal hardware that may be used to contain or implement program instructions according to an embodiment.

FIG. 3 is a block diagram of an exemplary printing system connected via a network to the exemplary internal hardware of FIG. 2.

FIG. 4 depicts a flow diagram of another exemplary method of incentivizing remote servicing of a printing device according to an embodiment.

### DETAILED DESCRIPTION

The following term shall have, for the purposes of this application, the meaning set forth below.

A “machine” refers to a mechanical instrument configured to provide a desired function. For example, a machine may provide a printing function. A machine may additionally or alternatively provide a copying function. A machine, for example, may be a printer, copier, fax, multi-function device and/or the like. Additional machine types may also be included within the scope of this disclosure.

A “printing device” is an electronic device that is capable of receiving commands and printing text and/or images on a substrate and/or scanning a document. Printing devices may include, but are not limited to, network printers, production printers, copiers, facsimile devices, other devices using ink or toner, and scanners. Printing devices may also perform a combination of functions such as printing/scanning/copying/faxing, in which case such devices may be considered to be multifunctional devices.

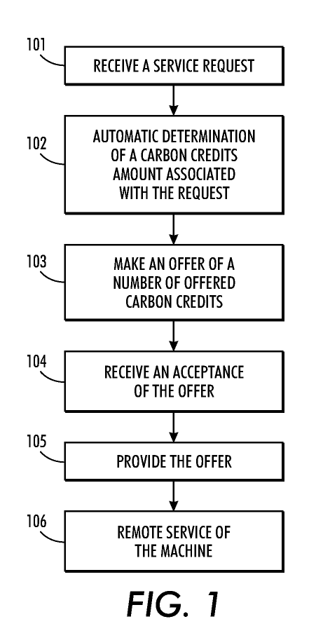

FIG. 1 depicts a flow diagram of a first exemplary method of incentivizing remote servicing of a machine according to an embodiment. As shown in FIG. 1, a request to service the machine may be received 101. In an embodiment, the request to service the machine may be received 101 from the customer. For example, the customer may contact a service center directly via an electronic device or a telecommunication device. Additional and alternate forms of communication may also be applicable.

In an alternate embodiment, the request to service the machine may be initiated by the machine itself. For example, the machine may be connected to the internet and may communicate with a system operated in conjunction with a service center. Alternatively, the machine may communicate with a system or a service center via other electronic, infrared, or telecommunication devices. The machine may further associate an error condition with an identification code such as a fault code which is provided to, for example, service engineer personnel.

A number of carbon credits associated with driving a vehicle from a service center to the machine location may be automatically determined 102 via a processor. The number of carbon credits may be determined 102, for example, based on a distance from a nearest service center to the customer and an average fuel consumption of a vehicle operated by the service center. A number of carbon credits may be offered 103 to a customer in order to incent acceptance of remote repair of the machine based, at least in part, on this determination. The offer may be made via an electronic device or a telecommunication device, such as through an e-mail, a fax, or a phone call. Other methods of providing an offer may also be used within the scope of this disclosure.

A customer may accumulate carbon credits in anticipation of satisfying a regulatory requirement for reporting purposes. Alternatively, the customer may participate in a voluntary greenhouse gas reduction program. Other reasons for accumulating carbon credits may include customer need or a desire for carbon credits.

In a further embodiment, the number of carbon credits offered 103 to the customer may include the number of carbon credits associated with driving a vehicle from a service center to a location of the machine. In an embodiment, the number of carbon credits offered 103 to the customer may be a sum of the number of carbon credits associated with driving a vehicle from a service center to a location of the machine and a number of accumulated carbon credits associated with one or more second service requests. The number of accumulated carbon credits may further include at least a portion of a total number of accumulated carbon credits associated with one or more second service requests.

Carbon credits may accumulate if a customer does not elect to receive associated carbon credits for a remote repair operation. At least a portion of the accumulated credits may be added to the credits associated with a current repair operation to incent a current customer to pursue a remote repair option. In an embodiment, an alternative incentive may be offered to the customer. If the customer elects the alternative incentive, the associated carbon credits may be added to the accumulated carbon credits. The accumulated carbon credits, or a portion thereof, may be offered to other customers as an incentive to elect remote repair.

Referring back to FIG. 1, the customer may accept the offer, and an acceptance of the number of offered carbon credits may be received 104. The acceptance may be received, for example, via an electronic device or a telecommunication device, such as through an e-mail, a data transmission, a fax, a phone call, and/or the like. The number of offered carbon credits may be provided 105 to the customer. For example, the carbon credits may be automatically deposited into an existing carbon credit account or issued to the customer through other methods. The machine may then be remotely serviced 106.

In an embodiment, a request to service one or more printing devices of a printing system may be received. A number of carbon credits associated with driving a vehicle from a service center to a location of the one or more printing devices may be determined. Based at least in part on this determination, a selected number of carbon credits may be offered to a customer. For example, the selected number of carbon credits may be equal to the determined number of carbon credits.

The selected number of carbon credits is offered to incent acceptance of remote repair of the one or more printing devices. Responsive to receiving an acceptance of the offer, remote service may be performed relative to the one or more printing devices. Remote service does not require a vehicle to be driven from the service center to the location for servicing of the one or more printing devices. In an embodiment, responsive to receiving a rejection of the offer, local service may be performed relative to the one or more printing devices.

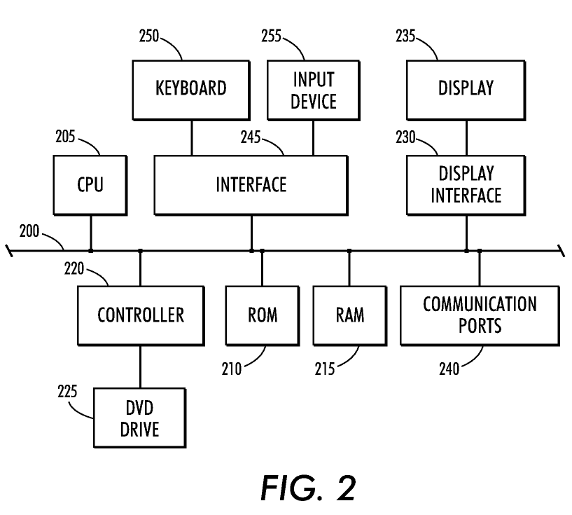

FIG. 2 depicts a block diagram of exemplary internal hardware that may be used to contain or implement program instructions according to an embodiment. A bus 200 serves as the main information highway interconnecting the other illustrated components of the hardware. CPU 205 is the central processing unit of the system, performing calculations and logic operations required to execute a program. Read only memory (ROM) 210 and random access memory (RAM) 215 constitute exemplary memory devices.

A controller 220 interfaces with one or more optional memory devices 225 to the system bus 200. These memory devices 225 may include, for example, an external or internal DVD drive, a CD ROM drive, a hard drive, flash memory, a USB drive or the like. As indicated previously, these various drives and controllers are optional devices.

Program instructions may be stored in the ROM 210 and/or the RAM 215. Optionally, program instructions may be stored on a tangible computer readable medium such as a compact disk, a digital disk, flash memory, a memory card, a USB drive, an optical disc storage medium, such as Blu-ray™ disc, and/or other recording medium.

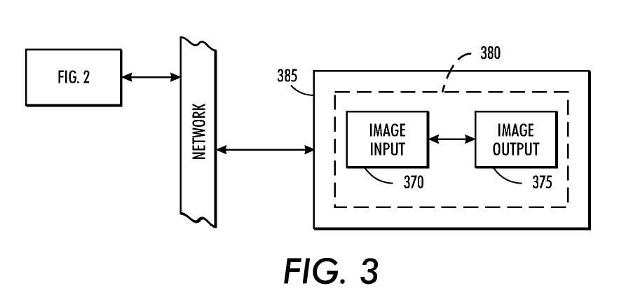

FIG. 3 depicts a block diagram of an exemplary printing system 385 connected via a network to the exemplary internal hardware of FIG. 2. Referring to FIG. 3, the one or more printing devices may include one of an image input device 370 and an image output device 375. The image input device 370 and an image output device 375 may combine to provide a copier or copy process 380.

An optional display interface 230 may permit information from the bus 200 to be displayed on the display 235 in audio, visual, graphic or alphanumeric format. Communication with external devices may occur using various communication ports 240. An exemplary communication port 240 may be attached to a communications network, such as the Internet or an intranet.

The hardware may also include an interface 245 which allows for receipt of data from input devices such as a keyboard 250 or other input device 255 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

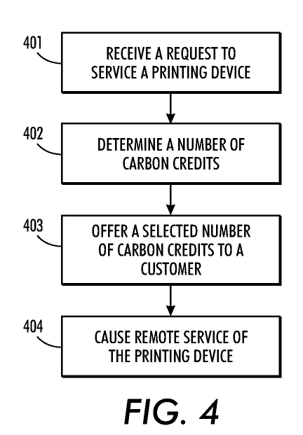

According to an embodiment, FIG. 4 depicts a flow diagram of another exemplary method of incentivizing remote servicing of a printing device. As shown in FIG. 4, a request to service the printing device may be received 401. In an embodiment, the request to service the printing device may be received 401 from the customer. The customer may contact a service center directly via, for example, an electronic device or a telecommunication device. In an alternate embodiment, the request to service the printing device may be initiated by the printing device itself. For example, the printing device may be connected to the internet and may communicate with a system operated in conjunction with a service center. Alternatively, the printing device may communicate with a system or a service center via other electronic, infrared, or telecommunication devices. The printing device may further associate an error condition with an identification code such as a fault code which is provided to, for example, service engineer personnel.

A number of carbon credits associated with driving a vehicle from a service center to a location of the printing device may be determined 402. The number of carbon credits may be determined 402, for example, based on a distance from a nearest service center to the customer and an average fuel consumption of a vehicle operated by the service center.

A selected number of carbon credits may be offered 403 to a customer to incent acceptance of remote repair of the printing device. The selected number of carbon credits may be offered 403 based at least in part on the determining 402. The offer may be made via an electronic device or a telecommunication device, such as through an e-mail, a fax, or a phone call. Other methods of providing an offer may also be used within the scope of this disclosure.

Remote service may be performed 404 relative to the printing device responsive to receiving an acceptance of the offer 403 of the selected number of carbon credits so that the vehicle need not be driven from the service center to the location of the printing device. The acceptance may be received, for example, via an electronic device or a telecommunication device, such as through an e-mail, a data transmission, a fax, a phone call, and/or the like. In an embodiment, responsive to receiving a rejection of the offer 403 of the selected number of carbon credits, local service may be performed relative to the printing device. In an embodiment, the selected number of carbon credits may be set to the determined number of carbon credits 402.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A service system for servicing a printing system, comprising:
a processor;
a printing device; and
a computer-readable storage medium in communication with the processor, the computer-readable storage medium including one or more programming instructions for:
receiving a request to service the printing device,
determining a number of carbon credits associated with driving a vehicle from a service center to a location of the printing device,
based at least in part on the determining, offering a selected number of carbon credits to a customer to incent acceptance of remote repair of the printing device, and
responsive to receiving an acceptance of the offer of the selected number of carbon credits, causing remote service to be performed relative to the printing device so that the vehicle need not be driven from the service center to the location of the printing device.

2. The service system of claim 1, wherein the computer-readable storage medium further includes one or more programming instructions for causing local service to be performed relative to the printing device responsive to receiving a rejection of the offer of the selected number of carbon credits.

3. The service system of claim 1, wherein the printing device comprises one of an image input device and an image output device.

4. The service system of claim 1, wherein the selected number of carbon credits is set to the determined number of carbon credits.

5. A system for providing an incentive to remotely service a machine, comprising:
a processor;
an output device in communication with the processor; and
a computer-readable storage medium in communication with the processor,
wherein the computer-readable storage medium includes one or more programming instructions for:
receiving a request to service the machine,
determining a number of carbon credits associated with driving a vehicle from a service center to a location of the machine,
determining a number of offered carbon credits,
offering the number of offered carbon credits to a customer to incent acceptance of remote repair of the machine,
receiving an acceptance of the number of offered carbon credits,
providing the number of offered carbon credits to the customer, and
issuing a command to remotely service the machine.

6. The system of claim 5, wherein the machine comprises a printing machine.

7. The system of claim 6, wherein the machine comprises one of an image input device and an image output device.

8. The system of claim 5, wherein determining the number of offered carbon credits comprises setting the number of offered carbon credits to the number of carbon credits.

9. The system of claim 5, wherein determining the number of offered carbon credits comprises determining a sum of the number of carbon credits associated with driving a vehicle from a service center to a location of the machine and a total number of accumulated carbon credits associated with one or more second service requests.

10. The system of claim 5, wherein determining the number of offered carbon credits comprises determining a sum of the number of carbon credits associated with driving a vehicle from a service center to a location of the machine and at least a portion of a total number of accumulated carbon credits associated with one or more second service requests.

11. A method of servicing a machine, comprising:
receiving a request to service the machine;
automatically determining, via a processor, a number of carbon credits associated with driving a vehicle from a service center to a location of the machine;
offering a number of offered carbon credits to a customer to incent acceptance of remote repair of the machine;
receiving an acceptance of the number of offered carbon credits;
providing the number of offered carbon credits to the customer; and
remotely servicing the machine.

12. The method of claim 11, wherein receiving the request comprises receiving the request from the customer.

13. The method of claim 11, wherein receiving the request comprises receiving the request from the machine.

14. The method of claim 11, wherein the machine comprises a printing machine.

15. The method of claim 11, wherein the number of offered carbon credits comprises setting the number of offered carbon credits to the number of carbon credits.

16. The method of claim 11, wherein the number of offered carbon credits comprises a sum of the number of carbon credits associated with driving a vehicle from a service center to a location of the machine and a total number of accumulated carbon credits associated with one or more second service requests.

17. The method of claim 11, wherein the number of offered carbon credits comprises a sum of the number of carbon credits associated with driving a vehicle from a service center to a location of the machine and at least a portion of a total number of accumulated carbon credits associated with one or more second service requests.

18. The method of claim 11, further comprising:
offering an additional incentive not related to carbon credits to the customer.

19. The method of claim 18, further comprising:
providing the additional incentive to the customer.
